(19) United States
(12) Patent Application Publication
(10) Pub. No.: US 2021/0326984 A1
(43) Pub. Date: Oct. 21, 2021

(54) POWER TRANSACTION DATA STORAGE SYSTEM BASED ON PRIVATE BLOCKCHAIN PLATFORM AND METHOD FOR VERIFYING AND DISTRIBUTEDLY STORING POWER TRANSACTION DATA USING THE SAME

(71) Applicant: WIZETECHNOLOGY, Daejeon (KR)

(72) Inventors: Young Jin KIM, Daejeon (KR); Seung Hyeon PARK, Daejeon (KR); Il Soon HAN, Daejeon (KR); Eun Ju RYU, Daejeon (KR)

(73) Assignee: WIZETECHNOLOGY, Daejeon (KR)

(21) Appl. No.: 17/357,269

(22) Filed: Jun. 24, 2021

Related U.S. Application Data
(63) Continuation of application No. PCT/KR2021/004867, filed on Apr. 19, 2021.

(30) Foreign Application Priority Data
Apr. 20, 2020 (KR) 10-2020-0047107

(51) Int. Cl. G06Q 40/04; G06Q 20/38; G06Q 50/06; H04L 9/32; H02J 3/00

(52) U.S. Cl. CPC G06Q 40/04; G06Q 20/389; H04L 2209/38; H04L 9/3239; H02J 3/008; G06Q 50/06

(57) ABSTRACT

Provided is a method for effectively distributedly storing and verifying power transaction major data such as bidding, matching, and calculation that takes place as prosumers and consumers participate in an energy transaction service in a private blockchain platform-based peer-to-peer (P2P) network environment. By applying a distributed ledger technology for storing and verifying reliable power transaction data by securing a consensus algorithm and a chaincode of a private blockchain, reliability of a power transaction service between energy market participants may be increased and an added value of reducing transaction costs may be created.

### CROSS-REFERENCE TO RELATED APPLICATIONS

The present application is a continuation of International Patent Application No. PCT/KR2021/004867, filed on Apr. 19, 2021, which is based upon and claims the benefit of priority to Korean Patent Application No. 10-2020-0047107 filed on Apr. 20, 2020. The disclosures of the above-listed applications are hereby incorporated by reference herein in their entirety.

### TECHNICAL FIELD

The present disclosure relates to a method for distributedly storing and verifying power transaction data based on a private blockchain platform, and more particularly, to a method for storing and verifying power transaction data between energy market participants such as prosumers and consumers in each node by applying a distributed ledger technology to an unforgeable private blockchain P2P network environment.

### BACKGROUND ART

In line with the development of the energy industry and national institutional changes, the introduction of new and renewable energy has increased, energy systems have been decentralized, and independent small-scale distributed resources in which a renewable energy power generation source and an energy storage device are combined have tended to gradually increase.

In this situation, as the spread of energy storage systems (ESS) is activated and interest in P2P power transactions between individuals is increasing, research to combine blockchains, a technology that has recently been attracting attention, has also been actively conducted.

Blockchains have been spread at a rapid pace beyond the financial industry to all areas of society such as manufacturing business and the public sector, and with the advent of a “hyper-connected society” in which everything is connected to each other in the future, blockchain technologies have come into prominence.

Through blockchains, large datasets may be maintained more safely and inexpensively than existing technologies without indirect costs for central calculation agencies, record reconciliation, and cybersecurity, and through distributed data storage devices, resilience to damage or attacks may be secured, and a value thereof is admitted with high stability of blockchains and programmable versatility through smart contracts.

However, the existing public blockchain has high security with an advantage in that anyone may participate therein, but is disadvantageous in that a transaction per second (TPS) is excessively lower than an existing network and costs for system maintenance unnecessarily increase because it is implemented by a method of performing encryption through a high-power GPU.

However, hyperledger fabric, which is to create a reliable private blockchain network without having a complex logical circuit by limiting participants who may participate in blockchains, provides business logic suitable for energy transactions.

Currently, the large-scale centralized power generation and transaction of the existing energy market are gradually changing into a small-scale distributed energy generation facility, and a safe and transparent energy transaction infrastructure based on two-way energy flow is required.

### DISCLOSURE

### Technical Problem

An aspect of the present disclosure provides a method for storing and verifying power transaction data, capable of providing an energy trading infrastructure for selling surplus power between energy market participants, such as prosumers and consumers, through a private blockchain platform suitable for a consortium environment, capable of encrypting in block units through a blockchain consensus algorithm and an encryption algorithm using a hash function by introducing a chaincode which is a reliable code execution technology even in a P2P network environment, and capable of performing integrity verification of power transaction data by applying a distributed ledger technology.

### Technical Solution

According to an aspect of the present disclosure, a business chaincode storing power transaction data in an energy transaction environment based on a private blockchain platform is secured and power transaction data is distributed and stored.

By correlating power transaction data with an encryption key storage unit, a transaction key, and a decryption key, the latest power transaction data is managed in a dedicated storage space of a chaincode, and by applying a distributed ledger technology, a block of power transaction data is generated through an encryption algorithm using a hash function and the block is propagated to a peer node participating in a private blockchain network so as to be distributed and stored.

After creating a transaction for storing energy market power transaction data and transmitting the transaction to a blockchain network to execute a chaincode, storing of power transaction data is attempted.

A transaction is verified by all nodes participating in the blockchain network according to power transaction data storage policy, and a consensus algorithm is performed to create a block and add the block to the blockchain.

A method for storing power transaction data based on blockchain chaincode includes an energy transaction bidding step defined in a chaincode and executed, a matching step, and a calculation step.

In the bidding step, a prosumer or consumer inputs a desired transaction price and a transaction volume, calls a bidding module to present an expected benefit to the prosumer and the consumer, and a bidding transaction is created and transmitted to the blockchain.

In the expected benefit step, after a prosumer or a consumer inputs a desired power transaction quantity using a surplus power generation quantity and a received power quantity of the prosumer and the consumer by time, an expected benefit logic is executed by calling an expected benefit module.

In the matching step, the matching module is called using a bid quantity and a bid price bidden by the prosumer or the consumer, and a matching transaction is generated and transmitted to and stored in the blockchain.

In the calculation step, after a calculation is executed by calling a calculation module such as a final charge, benefits, etc. for transaction details of the prosumer and the consumer, a calculation transaction is generated and transmitted to and stored in the blockchain.

### Advantageous Effects

A business model for reducing transaction costs and sharing reliable transaction information is secured by providing a safe and secure platform so that customers may trade surplus power with confidence through private blockchain technology.

A method of storing and verifying power transaction data that ensures availability of services and promotes economic efficiency by applying a blockchain with guaranteed excellent performance and a distributed data structure may be provided.

### DESCRIPTION OF DRAWINGS

FIG. 1 is a conceptual diagram of a hyperledger fabric blockchain network structure.

FIG. 2 is a conceptual diagram of a power transaction system based on hyperledger fabric blockchain.

FIG. 3 is a transaction procedure diagram for storing power transaction data.

FIG. 4 is a block diagram of a chaincode for storing power transaction data.

### BEST MODES

Technical terms used in this specification are used to merely illustrate specific embodiments, and should be understood that they are not intended to limit the present disclosure.

As far as not being defined differently, all terms used herein including technical or scientific terms may have the same meaning as those generally understood by an ordinary person skilled in the art to which the present disclosure pertains, and should not be construed in an excessively comprehensive meaning or an excessively restricted meaning.

In addition, general terms used in the description of the present disclosure should be construed according to definitions in dictionaries or according to its front or rear context, and should not be construed to have an excessively restrained meaning.

However, it is to be understood that the present invention is not limited to a specific disclosed form and various combinations may be made within the embodiments unless mentioned otherwise or as long as there is no contradiction therebetween.

In describing the present invention, if it is determined that a detailed description of known techniques associated with the present invention unnecessarily obscures the gist of the present invention, the detailed description thereof will be omitted.

In addition, it should be noted that the accompanying drawings are only for easy understanding of the spirit of the present invention, and should not be construed as limiting the spirit of the present invention by the accompanying drawings.

A prosumer refers to a person who may produce power through a small-scale power generation (e.g., solar power, wind power, etc.) and also may consume power, in addition to an existing power producer who produces power through an infrastructure (e.g., thermal power plant, nuclear power plant, hydroelectric power plant, etc.). As prosumers emerge, power transactions between individuals are required, and energy loss may be minimized by power supply through exchanging information on power demand and power supply in real time between energy prosumers . However, there is no environment in which individual prosumers conduct autonomous transactions without relying on a central trusted institution and safely store and verify power transaction data.

A commonly used blockchain technology corresponds to a public blockchain (Public Blockchain). In the case of a public blockchain, anyone may participate in a network and perform roles such as read, verification, and transaction 400 generation. In addition, since the public blockchain uses a consensus algorithm 300 that allows partial branches, a processing rate is also very slow.

In contrast, hyperledger fabric blockchain, which is a private blockchain, may limit network participation using a membership function. Therefore, only an authenticated user is responsible for verification, transaction 400 generation, and the like. The consensus algorithm 300 also has an advantage in that a processing rate is high using a fast RAFT-based algorithm without allowing partial branches.

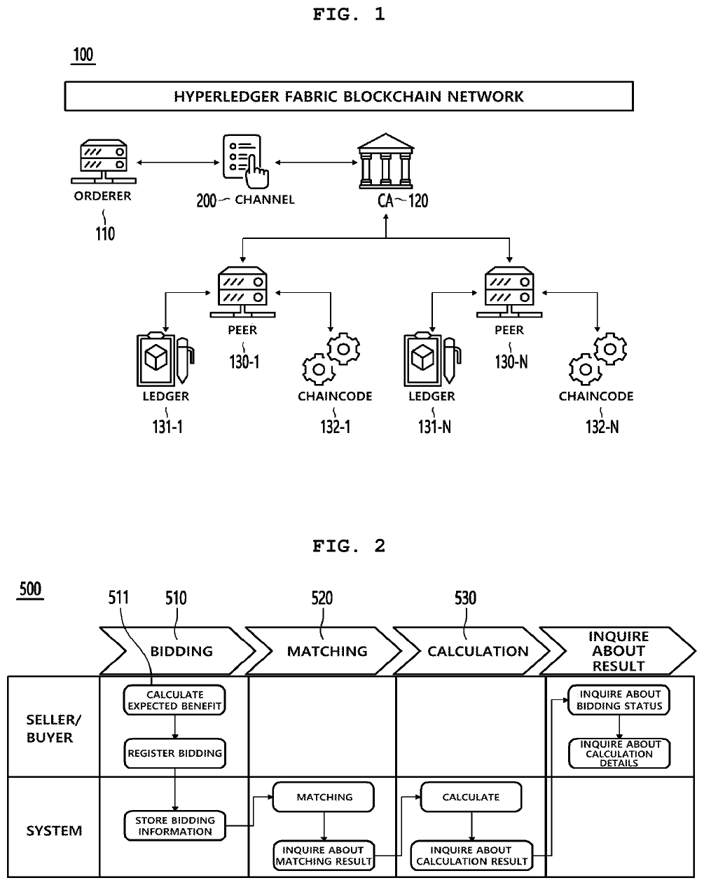

FIG. 1 is a conceptual diagram of the hyperledger fabric blockchain network 100 structure of the present disclosure. Hyperledger Fabric is a worldwide open-source platform organized for the development of inter-industry blockchain technology. Hyperledger Fabric is a private blockchain, allowing only authenticated users to record transaction history on a P2P network and also record execution history using a chaincode 132.

As shown in the structure of the private Hyperledger Fabric illustrated in FIG. 1, nodes constituting the hyperledger fabric blockchain include an orderer 110 node, a certificate authority (CA) 120 node, and a peer 130 node. The orderer node is responsible for ordering a transaction 400 by the consensus algorithm 300 and creating a block with a sorted transaction 400. The CA node checks an identity of members participating in the hyperledger fabric blockchain network 100 and manages their authority. The peer node is responsible for maintaining the hyperledger fabric blockchain network 100, processing proposals and responses of the transaction 400, and managing a ledger 131 and a chaincode 132.

Next, the channel 200 is a communication mechanism between groups within a consortium, which is very important in hyperledger fabric. The channel 200 enables data separation and confidentiality, and channel 200 configuration information contains all information necessary for an operation of the channel 200, such as authority information of the peer 130 that may access the channel 200.

FIG. 2 is a conceptual diagram of an energy transaction system. In a process to be performed by a user and the system with respect to the bidding 510, matching 520, and calculation 530 corresponding to main functions when operating the energy transaction service 500, the transaction 400 is created for power data such as energy transaction bidding 510, matching 520, and calculation 530, and transmitted to a private blockchain network to distribute and store power data.

When the prosumer or consumer inputs a desired transaction price and a transaction volume, the system derives a price range boundary section through a fee module to derive an expected benefit 511 in which both the prosumer and the consumer benefit.

The bidding 510 is executed through power sales and purchase information prepared by a customer based on the provided expected benefit 511.

The matching 520 is performed by inquiring about a bid quantity and a bid price bid by a prosumer or a consumer and prioritizing sales and purchase prices based on the bid information.

The calculation 530 for transaction details based on the bidding details participated by the customer is derived and a calculation quantity is distributed to each participant.

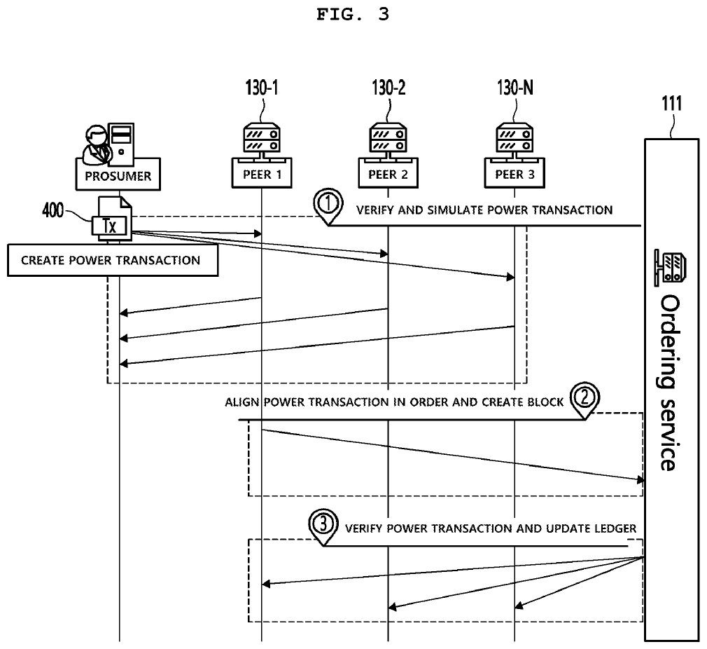

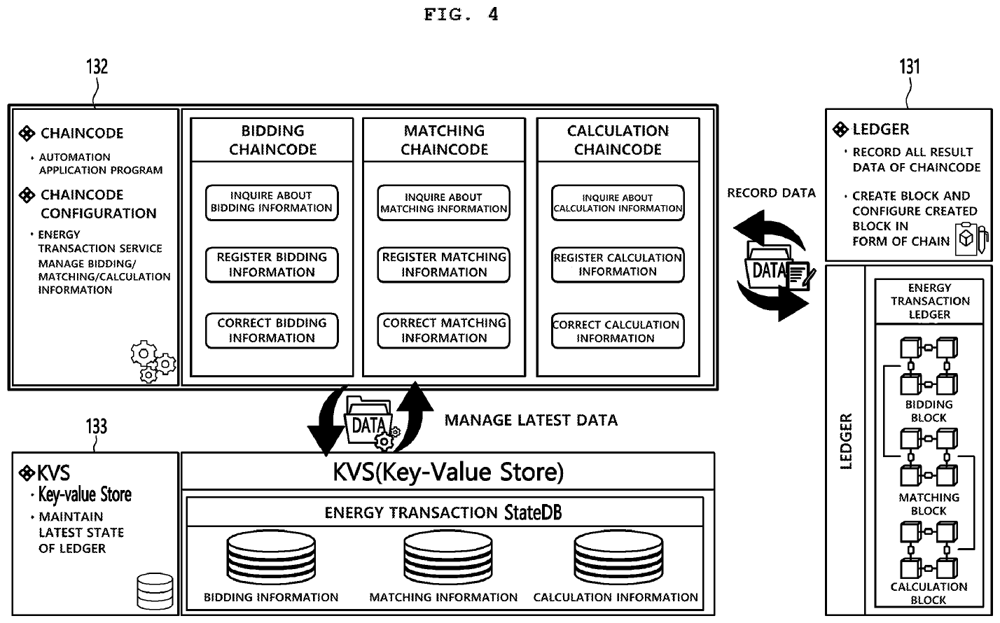

FIG. 3 is a process diagram of the transaction 400 for storing power transaction data of the present disclosure. To make an energy transaction, an energy prosumer or consumer creates a power transaction data storage transaction 400 and transmits the transaction 400 to all peer 130 nodes. All peer 130 nodes execute the chaincode 132 according to a power transaction data storage guarantee policy to verify the transaction 400 and perform simulation.

If a simulation result value satisfies the power transaction data storage guarantee policy, the result value is transmitted to an ordering service 111. The orderer 110 arranges the transaction 400 in order and creates a block and transmits the block to all peer 130 nodes, and all peer 130 nodes determine whether the received block satisfies the guarantee policy, adds a new block, and updates a state of the ledger 131.

FIG. 4 is a block diagram of the chaincode 132 for storing the power transaction data of the present disclosure. Chaincode 132 implements contract conditions or rules as business logic so that processing may always be performed according to the agreed rules, stores the latest state of data in a key-value store (KVS) 133 and is executed by the implemented business logic. In the present disclosure, by implementing power transaction data storage business logic of the energy transaction bidding 510, matching 520, and calculation 530 of the chaincode 132, the latest power transaction data is stored in the KVS 133 and power transaction data storage history is added as a block.

TABLE 1

| | | Method | Function |
|---|---|---|---|
| Class name | Method name | description | description |
| BiddingChaincode | getBiddingInfo | Inquire about | Inquire about |
| | | bidding | bidding |
| | | information | information |
| | InsertBidding | Register Bidding | Register bidding |
| | | information | information such |
| | | | as bid quantity, |
| | | | bid price, etc. |
| | updateBidding | Correct Bidding | Correct |
| | | information | registered |
| | | | bidding |
| | | | information |
| MatchingChaincode | GetMatchingInfo | Inquire about | Inquire about |
| | | matching | matching |
| | | information | information |
| | | | between |
| | | | seller-buyer |
| | insertMatching | Register | Register |
| | | matching | transaction |
| | | information | settlement |
| | | | information such |
| | | | as contract |
| | | | quantity, |
| | | | contract price, |
| | | | etc. |
| | updateMatching | Correct matching | Correct |
| | | information | registered |
| | | | matching |
| | | | information |
| CalculationChaincode | getCalculationInfo | Inquire about | Inquire about |
| | | calculation | calculation |
| | | information | information of |
| | | | each customer |
| | insertCalculation | Register | Register |
| | | calculation | calculation |
| | | information | information such |
| | | | as calculation |
| | | | quantity, |
| | | | benefit, etc. |
| | updateCalculation | Correct | Correct |
| | | calculation | registered |
| | | information | calculation |
| | | | information |

Table 1 shows the chaincode 132 for each type of energy transaction, in which power transaction data is classified, the name of the JAVA-side actual method (function) to be performed, name of actual method (function) of JAVA side to perform, parameter, type, return type, and performing contents are shown, and a process of calling each power transaction data storage chaincode 132 in an energy transaction service 500 is shown.

TABLE 2

| | | | Data type | |
|---|---|---|---|---|
| Classification | Column name | Column | description | Index |
| Calculation | CUST_ID | Customer ID | Character | Y |
| | | | string | |
| | CALCULATION_YM | Calculation | Character | Y |
| | | year month | string | |
| | CALCULATION_TYPE_CD | Calculation | Character | |
| | | type code | string | |
| | SUPPLY_QTY | Supply | Number | |
| | | quantity | (integer) | |
| | GEN_QTY | Surplus | Number | |
| | | generation | (integer) | |
| | | quantity | | |
| | BEFORE_CAL_QTY | Calculation | Number | |
| | | quantity | (integer) | |
| | | before | | |
| | | transaction | | |
| | BEFORE_CHARGE | Electric | Number | |
| | | charge | (integer) | |
| | | before | | |
| | | transaction | | |
| | AFTER_CAL_QTY | Calculation | Number | |
| | | quantity | (integer) | |
| | | after | | |
| | | transaction | | |
| | AFTER_CHARGE | Electric | Number | |
| | | charge after | (integer) | |
| | | transaction | | |
| | REVENUE_EXPENSE | Sales | Number | |
| | | revenue | (integer) | |
| | FINAL_CHARGE | Final charge | Number | |
| | | | (integer) | |
| | BENEFIT | Benefit | Number | |
| | | | (integer) | |
| Bidding | CUST_ID | Customer ID | Character | Y |
| | | | string | |
| | BIDDING_YM | Bidding year | Character | Y |
| | | month | string | |
| | BIDDING_TIMESTAMP | Bidding time | Character | |
| | | stamp | string | |
| | BIDDING_TYPE_CD | Bidding type | Character | |
| | | code | string | |
| | DESIRE_PRICE | Desired | Number | |
| | | selling or | (integer) | |
| | | purchasing | | |
| | | price | | |
| | DESIRE_QTY | Desired | Number | |
| | | selling or | (integer) | |
| | | purchasing | | |
| | | quantity | | |
| | EXP_BENEFIT | Expected | Number | |
| | | benefit | (integer) | |
| | LIMIT_PRICE | Selling | Number | |
| | | upper limit | (integer) | |
| | | or purchase | | |
| | | lower limit | | |
| Matching | CONTRACT_TYM | Contract | Character | Y |
| | | year month | string | |
| | SALE_USER_ID | Seller ID | Character | Y |
| | | | string | |
| | BUY_USER_ID | Buyer ID | Character | Y |
| | | | string | |
| | CONTRACT_QTY | Contract | Number | |
| | | quantity | (integer) | |
| | CONTRACT_PRICE | Contract | Number | |
| | | price | (integer) | |
| | CONTRACT_STATE_CD | Contract | Character | |
| | | state code | string | |

Table 2 is a schema data structure for recording actual power transaction data in the KVS 133, and main data of power transaction in the bidding 510, matching 520, and calculation 530 of the energy transaction service 500 are distributedly stored in a block to secure reliability and guarantee data transparency.

Although preferred embodiments according to the present disclosure have been described above, the present disclosure is not limited thereto, and should be interpreted by those skilled in the art to which the present invention pertains to encompass various variations without departing from the gist of the present invention appended in the claims. The claims are intended to cover such variations.

### DESCRIPTION OF REFERENCE NUMERALS

100: hyperledger fabric blockchain network

110: orderer

111: orderer Service

120: CA (Certificate Authority)

130: peer

131: ledger

132: chaincode

133: KVS (Key-Value Store)

200: channel

300: consensus algorithm

400: transaction

500: energy transaction service

510: bidding

511: expected benefit

520: matching

530: calculation

1. A power transaction data storage system based on blockchain, wherein a transaction is generated for power transaction data related to bidding, matching, and calculation in an energy transaction service based on hyperledger fabric blockchain network, and verified by executing a chaincode.

2. The power transaction data storage system of claim 1, comprising:
a bidding module transmitting a transaction including the power transaction data information to the Hyperledger Fabric blockchain network;
a matching module providing matching information for concluding a transaction between customers including a prosumer and a consumer; and
a calculation module calculating a benefit for each customer based on the matching information.

3. A method for verifying and distributedly storing power transaction data based on blockchain to mediate a power transaction between a prosumer and a consumer using the power transaction data storage system of claim 1, the method comprising:
a bidding operation in which the bidding module receives a desired transaction price and a transaction volume from the prosumer or the consumer, proposes an expected benefit to the prosumer or the consumer, creates a bidding transaction, and transmits the created bidding transaction to a blockchain;
a matching operation in which the matching module creates a matching transaction using a bidding quantity and a bidding price bidden by the prosumer or the consumer and transmits the created matching transaction to the blockchain to store the transaction; and
a calculating operation in which the calculation module executes calculation for a final charge, a benefit for transaction details of the prosumer and the consumer, creates a calculation transaction, and then transmits the created transaction to the blockchain to store the transaction.

4. The method of claim 3, wherein,
the bidding operation includes an expected benefit operation of receiving a desired power transaction quantity from the prosumer or the consumer using surplus power generation quantity and a supply quantity of the prosumer and the consumer for each time zone and calling an expected benefit module to execute an expected benefit logic.

5. A method for verifying and distributedly storing power transaction data based on blockchain to mediate a power transaction between a prosumer and a consumer using the power transaction data storage system of claim 2, the method comprising:
a bidding operation in which the bidding module receives a desired transaction price and a transaction volume from the prosumer or the consumer, proposes an expected benefit to the prosumer or the consumer, creates a bidding transaction, and transmits the created bidding transaction to a blockchain;
a matching operation in which the matching module creates a matching transaction using a bidding quantity and a bidding price bidden by the prosumer or the consumer and transmits the created matching transaction to the blockchain to store the transaction; and
a calculating operation in which the calculation module executes calculation for a final charge, a benefit for transaction details of the prosumer and the consumer, creates a calculation transaction, and then transmits the created transaction to the blockchain to store the transaction.

6. The method of claim 5, wherein,
the bidding operation includes an expected benefit operation of receiving a desired power transaction quantity from the prosumer or the consumer using surplus power generation quantity and a supply quantity of the prosumer and the consumer for each time zone and calling an expected benefit module to execute an expected benefit logic.
